(19) United States
(12) Patent Application Publication
(10) Pub. No.: US 2002/0020349 A1
(43) Pub. Date: Feb. 21, 2002

(54) Paint roller and extension pole

(76) Inventors: Brian E. Woodnorth, Whitefish Bay, WI (US); Craig S. Serio, New Berlin, WI (US); Brian C. Bone, St. Louis, MO (US); Heath A. Doty, Richmond Heights, MO (US); Marc Hunter, Edwardsville, IL (US)

Correspondence Address: FOLEY & LARDNER, Firstar Center, 777 East Wisconsin Avenue, Milwaukee, WI, 53202-5367, US

(21) Appl. No.: 09/823,792

(22) Filed: Mar. 30, 2001

Related U.S. Application Data
(60) Provisional application No. 60/193,219, filed on Mar. 30, 2000.

(51) Int. Cl. B05C 13/00

(52) U.S. Cl. 118/500

(57) ABSTRACT

An extension for a paint applicator includes a first end configured to be coupled to a paint applicator, a distal portion coupled to the first end, a first, second, third and fourth coupled angled portions, and a proximal portion coupled to the fourth angled portion parallel to a primary axis. Another ergonomic extension includes a first end configured to be coupled to a paint applicator, a distal portion coupled to the first end extending parallel to a primary axis, a first hoop coupled to the distal portion, a proximal portion coupled to the first hoop, and a second hoop coupled to the proximal portion.

### CROSS REFERENCE TO RELATED APPLICATIONS

The present application claims priority under 35 U.S.C. § 119 from U.S. Provisional Patent Application No. 60/1 93,219 titled “Paint Accessories” filed Mar. 30, 2000 (Attorney Docket No. 62759-341), the full disclosure of which is hereby incorporated by reference.

### FIELD OF THE INVENTION

The present invention relates to paint accessories for applying coatings such as paint, varnish, stain and the like to walls. In particular, the present invention relates to such accessories that are configured to be more easily held and manipulated when applying paint or other coatings to reduce user fatigue.

### BACKGROUND OF THE INVENTION

Paint rollers are commonly employed to quickly and easily apply coatings such as paint, stain or varnish to wall surfaces. Paint rollers typically include a frame, one or more cages rotatably mounted upon a distal end of the frame and a replaceable roller cover which includes a sleeve or core carrying a paint-applying medium such as fabric, foam, sponge material and the like. In particular applications, the roller cover may be provided with patterns for such activities as faux finishing. Although less desirable, some paint rollers utilize a single structure in lieu of the cage and the removable roller cover.

Paint rollers are commonly used to apply paint to walls and ceilings that cannot normally be reached by the user. As a result, many paint rollers are adapted for use with an elongated extension hollow axial end with internal threads configured to threadably engage corresponding external threads of the extension pole. The extension pole is generally an elongate linear, uni-axial pole formed from wood, aluminum or a rigid polymer.

Although such paint rollers and extension poles have been used for years, such existing paint roller and extension pole systems have several disadvantages. For example, when the paint roller is used without the extension pole, the open axial end of the handle is susceptible to becoming filled with paint or paint solvents and is difficult to clean. Although the extension pole does enable the paint roller to apply paint to otherwise difficult-to-reach areas, prolonged use of the paint roller and extension pole may be fatiguing. Maintaining a sure grip on the extension pole also creates fatigue.

### SUMMARY OF THE INVENTION

The present invention relates to an extension for a paint applicator including a first end configured to be coupled to the paint applicator, a distal portion coupled to the first end where the distal portion is parallel to a primary axis. The extension further includes a first angled portion coupled to the distal portion, a second angled portion coupled to the first angled portion and a proximal portion coupled to the second angled portion parallel to the primary axis.

The present invention further relates to an extension for a paint applicator including a first end configured to be coupled to the paint applicator, and a distal portion coupled to the first end parallel to a primary axis. The extension further includes an angled portion coupled to the distal portion, a proximal portion coupled to the second angled portion, where the proximal portion is parallel to the primary axis and an end portion substantially parallel to the angled portion.

The present invention further relates to an extension for a paint applicator including a first end configured to be coupled to the paint applicator, a distal portion coupled to the first end, the distal portion extending parallel to a primary axis, and a first angled portion coupled to the distal portion. The extension further includes a second angled portion coupled to the first angled portion, a third angled portion coupled to the second angled portion, where the third angled portion is substantially parallel to the first angled portion. The extension also includes a fourth angled portion coupled to the third angled portion, where the fourth angled portion is substantially parallel to the second angled portion, and a proximal portion coupled to the fourth angled portion, where the proximal portion is parallel to the primary axis.

The present invention further relates to an extension for a paint applicator, including a first end configured to be coupled to the paint applicator, and a distal portion coupled to the first end, where the distal portion extends parallel to a primary axis. The extension further includes a first hoop coupled to the distal portion, a proximal portion coupled to the first hoop and a second hoop coupled to the proximal portion.

### BRIEF DESCRIPTION OF THE DRAWINGS

FIG. 1 is a perspective view of a paint roller and extension system according to an exemplary embodiment of the present invention;

FIG. 2 is a perspective view of a paint roller and extension system according to an alternative embodiment of the present invention;

FIG. 3 is a partial perspective view of the paint roller and extension system shown in FIG. 1;

FIG. 4 is a partial cross-sectional view of the paint roller and extension system shown in FIG. 3, taken along line 4-4;

FIG. 5 is a front elevational view of an extension according to an alternative embodiment of the present invention;

FIG. 6 is a front elevational view of an extension according to an alternative embodiment of the present invention;

FIG. 7 is a front elevational view of an extension according to an alternative embodiment of the present invention;

FIG. 8 is a front elevational view of an extension according to an alternative embodiment of the present invention;

FIG. 9 is a front elevational view of an extension according to an alternative embodiment of the present invention, showing an arm brace attached to a proximal end of the extension;

FIG. 10 is a perspective view of a paint roller and extension system according to an alternative embodiment of the present invention, showing an arm brace attached to a proximal end of the extension;

FIG. 10A is a sectional view of the system of FIG. 10 taken along line 10A-10A;

FIG. 11 is a perspective view of a paint roller and extension system according to the extension shown in FIG. 7, shown in a working environment;

FIG. 12 is a perspective view of a paint roller and extension system according to the extension shown in FIG. 7, shown in a working environment, held in an alternative grip position;

FIG. 13 is a front elevational view of an extension according to an alternative embodiment of the present invention;

FIG. 14 is a front elevational view of an extension according to an alternative embodiment of the present invention;

FIG. 15 is a front elevational view of an extension according to an alternative embodiment of the present invention;

FIG. 16 is a perspective view of an arm support capable of use in the extension systems disclosed;

FIG. 17 is a side view of the arm support shown in FIG. 16;

FIG. 18 is a perspective view of an alternative arm support capable of use in the extension systems disclosed; and

FIG. 19 is a top elevational view of an alternative embodiment of the paint roller and extension system of FIG. 1.

FIG. 20 is a fragmentary side view of an extension according to an alternative embodiment.

### DETAILED DESCRIPTION OF THE PREFERRED EMBODIMENTS

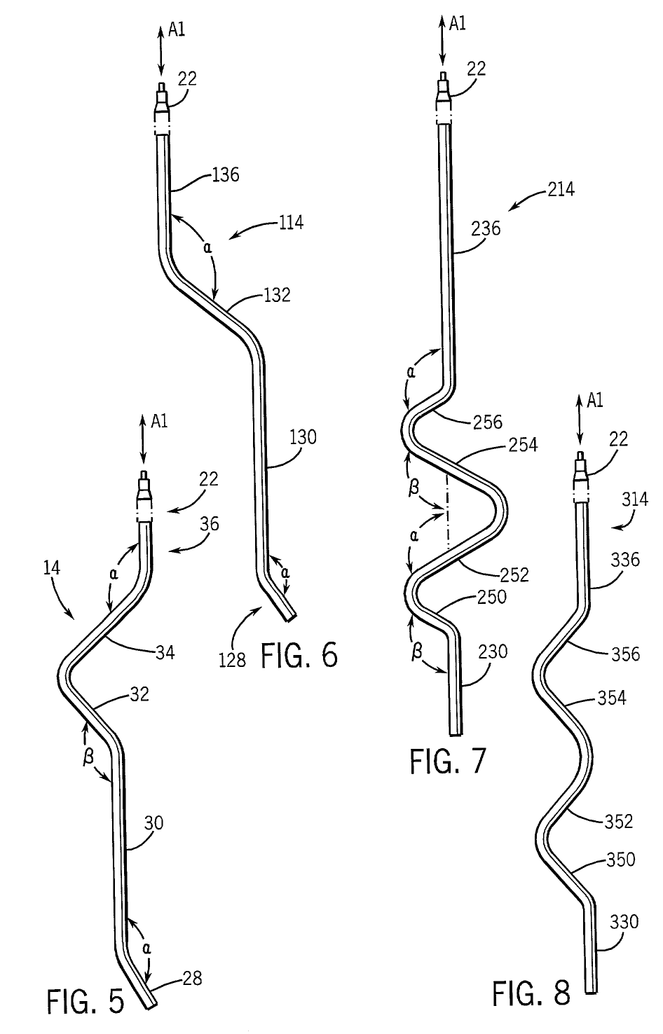

FIGS. 1 and 5 illustrate extension system 10. FIG. 1 is a perspective view of paint roller and extension system 10 generally including paint roller 12 and extension pole 14. FIG. 5 depicts the preferred embodiment of extension pole 14 separated from roller 12. Paint roller 12 generally includes frame 16 having handle portion 18 and rolling paint-applying member 20. Handle 18 is located at a proximal end of paint roller 12 and is configured to be removably attached to distal end 22 of extension pole 14. Rolling paint applying member 20 is rotatably supported on a distal end of frame 16 and includes an outer paint carrying and applying medium such as fabric, foam, sponge or the like. In the exemplary embodiment, member 20 preferably comprises a removable roller cover slid over a cage rotatably mounted upon frame 16. Alternatively, member 20 may comprise a single member rotatably mounted upon frame 16. Although member 20 is illustrated as having a solid unbroken outer circumferential surface of paint-applying medium, this surface may alternatively be patterned as desired. In addition, in lieu of having a single member 20, roller 12 may alternatively include two or more such members spaced from one another on a distal end of frame 16.

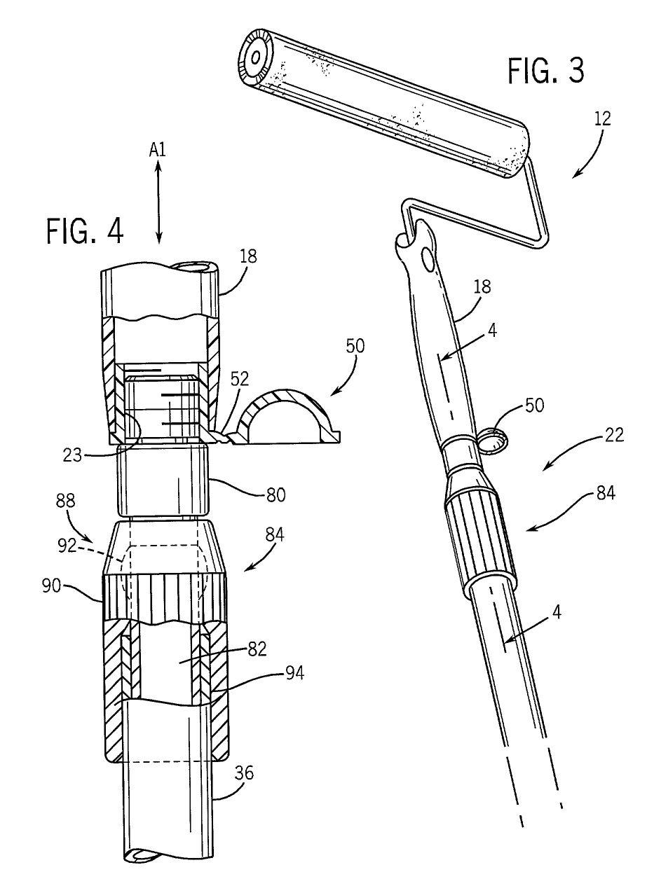

FIGS. 3 and 4 illustrate distal end 22 of extension pole 14 and paint roller 12 in greater detail. End 22 is configured to be coupled to a variety of paint applicators or painting accessories including paint rollers, paint brushes, paint pads, scrapers, sprayers, wire brushes, etc. In an exemplary embodiment of extension pole 14, paint roller 12 is coupled to end 22 by threads disposed on end 22. Alternatively, paint roller 12 may be coupled to end 22 by a variety of fastening techniques including clamps, a key-way snap fit, etc.

As shown by FIGS. 3 and 4, handle portion 18 includes a hollow, internally threaded axial end 24 adapted to threadably receive distal end 22 of extension pole 14. When roller 12 has been fully rotated into a tight retaining position against the axial end of extension pole 14, such that roller 12 may no longer be rotated about primary vertical axis A1, member 20 is supported for rotation along an axis A2 substantially perpendicular to primary vertical axis A1.

Handle 18 additionally includes end cap 50. End cap 50 is bulbous or semi-spherical in shape and is configured to close the hollow internally threaded opening of handle portion 18 when roller 12 is not being used with extension pole 14. End cap 50 is preferably hinged to handle 18. As a result, end cap 50 may be pivoted between an open position (shown in FIG. 3) allowing distal end 22 of pole 14 to be inserted into the axial end of opening 18 and a closed position (not shown) in which end cap 50 closes the internally threaded portion 23 of handle 18. In the exemplary embodiment, end cap 50 is hinged or pivotably coupled to handle 18 by means of living hinge 52. In other words, end cap 50 is pivotably coupled to handle 18 by means of a flexible and resilient flap preferably integrally formed as part of a single unitary body with end cap 50. Although less desirable, end cap 50 may alternatively be pivotably coupled to handle 18 by other pivot mechanisms such as with pins and the like. End cap 50 is preferably formed from a soft compressible resilient rubber-like material to provide an easily gripable and safer end to handle 18 of roller 12. In addition to eliminating sharp edges or corners which may cause blisters or fatigue, the bulbous shape of end cap 50 is also more aesthetically attractive.

As shown by FIG. 1, extension pole 14 is removably coupled to end 24 of roller 12 and generally includes end grip portion 28, proximal portion 30, angled portion 32, angled portion 34, distal portion 36 and handle 38. End grip portion 28 extends at a distal most end of extension pole 14 along an axis A3 oblique to axis A4 along which proximal portion 30 extends. In the exemplary embodiment, end grip portion 28 includes an outer surface of a soft compressible elastomer, foam, or rubber to facilitate gripping. The material is preferably solvent resistant. In the exemplary embodiment, portion 28 has a rigid core surrounded by Santoprene™, which is a polypropylene based thermoplastic elastomer with vulcanized rubber disposed in it.

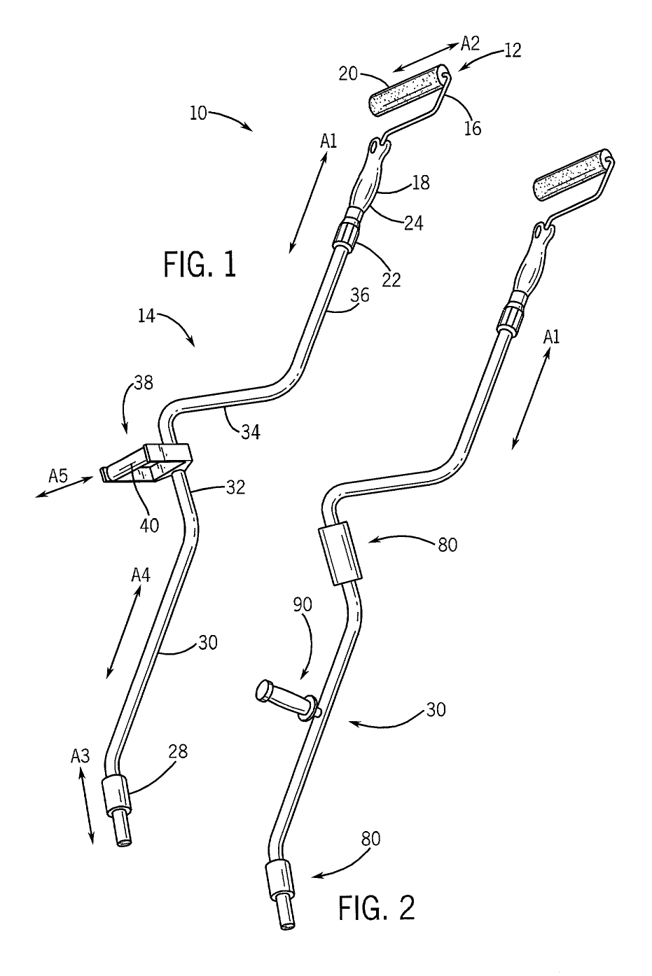

Angled portions 32 and 34 extend between proximal portion 30 and distal portion 36. Angled portion 32 obliquely extends from proximal portion 30 while angled portion 34 obliquely extends from distal portion 36. Angled portion 32 supports handle 38. Handle 38 projects from angled portion 32 and provides an elongate member 40 configured to be grasped between the user's fingers and thumb. Alternatively, as shown in FIG. 2, handle 38 may be replaced with handle 90 disposed on proximal portion 30. As shown by FIG. 1, portions 28, 30, 32, 34 and 36 extend in a single plane perpendicular to axis A2 when roller 12 is fully threadably engaged with or otherwise coupled to distal portion 22. Likewise, portion 40 of handle 38 extends along an axis A5 substantially parallel to axis A2. Extension pole 14 allows a user to securely and reliably position rolling paint applying member 20 against a wall or ceiling surface and to roll member 20 along the wall or ceiling surface with less fatigue.

End 22 is coupled to a distal portion 36. Distal portion 36, as shown in FIG. 5, is a straight, cylindrical member which is substantially parallel with primary axis A1.

As best shown by FIG. 5, distal portion 36 is coupled to a first angled portion 34. First angled portion 34, as shown in FIG. 5, is a cylindrical member which angles obliquely away from primary axis A1. In an exemplary embodiment, first angled portion 34 extends away from vertical axis A1 at an angle (α) between 75° and 160°. In a preferred embodiment, angle (α) is between 120° and 140°.

First angled portion 34 is coupled to a second angled portion 32. Second angled portion 32, as shown in FIG. 5, is a cylindrical member which angles obliquely toward primary axis A1. In an exemplary embodiment, second angled portion 32 angles obliquely toward primary axis A1 at an angle (β) between 10° and 170°. In a preferred embodiment, angle (α) is between 120° and 140°.

Second angled portion 32 is coupled to a proximal portion 30. Proximal portion 30, as shown in FIG. 5, is a straight, cylindrical member which is substantially parallel with primary axis A1.

Proximal portion 30 is coupled to end portion 28. End portion 28, as shown in FIG. 5, is a cylindrical member which angles away from primary axis A1. In an exemplary embodiment, end portion 28 angles away from primary axis A1 at an angle (α) between 30° and 330°. Furthermore, end portion 28 is substantially parallel to second angled portion 32. End portion 28 and second angled portion 32 are between 10 and 35 inches apart. In a preferred embodiment, end portion 28 and second angled portion 32 are 28 inches apart. In an exemplary embodiment, end portion 28 is 5.83 inches, second angled portion 32 is 5.18 inches, and first angled portion 34 is 8.46 inches.

The two angled portions 32 and 34, and end portion 28 form an ergonomic, selective gripping structure for extension 14. A user may grip extension 14 with one hand on end portion 28, and a second hand on second angled portion 32. Alternatively, a user may grip extension 14 with a first hand on proximal portion 30, and a second hand on second angled portion 32. Placing hands in these positions offers the user a comfortable feel while using extension 14. Stress and fatigue on the user is lessened by allowing the user to hold extension 14 is a more natural position on parallel portions 32 and 28, or portions 32 and 30, rather than holding a typical, straight extension pole. The user may selectively choose from two gripping positions based on criteria such as user comfort, space constraints, etc. Extension 14 is well suited for use with a paint applicator when applying paint to a vertical surface. Extension 14 provides hand relief, and upper body relief when using on a vertical surface.

To further increase user comfort, extension 14 may be alternatively be fitted with grips 80 (FIG. 2). Grips 80, which may be a soft cushion foam, are shown disposed on end portion 28 and angled portion 32. Additionally, grips 80 may be disposed on angled portion 34 or proximal portion 30. Grips may be capable of elastic deformation in user's hands, thereby increasing comfort. Alternatively, grips may be a flexible rubber, Santoprene™or elastomer which increases user's grip.

Referring to FIG. 5, extension 14 enables a user's first hand to be positioned on one side of proximal portion 30 while the user's second hand is on a second side of proximal portion 30. By having hands on either side of proximal portion 30, the overall force generated by the user's hands result in a force roughly in line with proximal portion 30. As a result, a user may develop force more directed along an axis to primary axis A1, thus resulting in less effort.

FIG. 6 depicts extension pole 114, an alternative embodiment of extension pole 14. Extension pole 114 is similar to extension pole 14 except that extension pole 114 includes end grip portion 128, proximal portion 130, angled portion 132 and distal portion 136. Portions 128, 130, 132 and 136 extend in a single plane substantially perpendicular to the axis A2 about which roller member 20 (shown in FIG. 1) rotates. Although not illustrated, extension pole 114 may further include a handle mounted to angled portion 132, wherein the handle is substantially identical to handle 38 shown in FIG. 1. Similar to distal portion 36, distal portion 1 36 includes an externally threaded distal end 22 configured to be releasably secured to roller 12. Although less desirable, extensions 14 and 114 may alternatively be permanently affixed to and as part of roller 12 fixed to and formed as part of roller 12.

End 22 is coupled to a distal portion 136. Distal portion 136, as shown in FIG. 6, is a straight, cylindrical member which is substantially parallel with primary axis A1.

Distal portion 136 is coupled to a first angled portion 132. First angled portion 132, as shown in FIG. 6, is a cylindrical member which angles away from primary axis A1. In an exemplary embodiment, first angled portion 132 extends away from primary axis A1 at an angle (α) between 10° and 170°. In a preferred embodiment, angle (α) is between 120° and 140°.

First angled portion 132 is coupled to a proximal portion 130. Proximal portion 130, as shown in FIG. 5, is a straight, cylindrical member which is substantially parallel with primary axis A1.

Proximal portion 130 is coupled to end portion 128. End portion 128, as shown in FIG. 6, is a cylindrical member which angles away from primary axis A1. In an exemplary embodiment, end portion 128 angles away from primary axis A1 at an angle (α) between 120° and 140°. Furthermore, end portion 128 is substantially parallel to first angled portion 132. End portion 128 and first angled portion 132 are between 10 and 37 inches apart. In a preferred embodiment, end portion 128 and first angled portion 132 are 30 inches apart.

First angled portion 132, proximal portion 130 and end portion 128 form an ergonomic, selective gripping structure for extension 114. Extension 114 may be gripped by a user with one hand on end portion 128, and a second hand on first angled portion 132. Alternatively, extension 114 may be gripped with a first hand on proximal portion 130, and a second hand on first angled portion 132. Extension 114 offers the user a comfortable feel. Stress and fatigue on user is lessened by allowing user to hold extension 114 in a more natural position on parallel portions 132 and 128, or portions 132 and 130, rather than holding a typical, straight extension pole. The user may selectively choose from two gripping positions based on criteria such as user comfort, space constraints, etc.

To further increase user's comfort, extension 114 may be alternatively be fitted with grips (not shown). Grips may be a soft cushion foam disposed on angled portion 132, and end portion 128. Furthermore, proximal portion 130 may also be fitted with grips. Grips may be capable of elastic deformation in user's hands, thereby increasing comfort. Alternatively, grips may be a flexible rubber, Santoprene™ or elastomer which increases user's grip. Furthermore, extension 114 may be fitted with a handle similar to handle 38, located on first angled portion 132.

FIG. 7 illustrates an alternative embodiment of an extension pole 214. Extension pole 214 includes a first end 22, distal portion 236, first angled portion 256, second angled portion 254, third angled portion 252, fourth angled portion 250. First end 22, as discussed above, is configured to be coupled to a variety of paint applicators and accessories. In an exemplary embodiment of extension pole 214, a paint applicator is coupled to end 22 by threads disposed on end 22. Alternatively, a paint applicator may be coupled to end 22 by a variety of fastening techniques including clamps, key-way snap fits, etc.

End 22 is coupled to a distal portion 236. Distal portion 236, as shown in FIG. 7, is a straight, cylindrical member which is substantially parallel with primary axis A1.

Distal portion 236 is coupled to a first angled portion 256. First angled portion 256, as shown in FIG. 7, is a cylindrical member which angles away from primary axis A1. In an exemplary embodiment, first angled portion 256 extends away from primary axis A1 at an angle (α) between 30° and 170°. In a preferred embodiment, angle (α) is between 120° and 140°.

First angled portion 256 is coupled to a second angled portion 254. Second angled portion 254, as shown in FIG. 7, is a cylindrical member which angles obliquely toward primary axis A1. In an exemplary embodiment, second angled portion 254 angles obliquely toward primary axis A1 at an angle (β) between 30° and 170°. In a preferred embodiment, angle (α) is between 120° and 140°.

Second angled portion 254 is coupled to a third angled portion 252. Third angled portion 252, as shown in FIG. 7, is a cylindrical member which angles obliquely away from primary axis A1. In an exemplary embodiment, third angled portion 252 angles obliquely away primary axis A1 at an angle (α) between 30° and 170°. In a preferred embodiment, angle (α) is between 120° and 140°.

Third angled portion 252 is coupled to a fourth angled portion 250. Fourth angled portion 250, as shown in FIG. 7, is a cylindrical member which angles obliquely toward primary axis A1. In an exemplary embodiment, fourth angled portion 250 angles obliquely toward primary axis A1 at an angle (β) between 30° and 170°. In a preferred embodiment, angle (β) is between 120° and 140°.

Fourth angled portion 250 is coupled to a proximal portion 230. Proximal portion 230, as shown in FIG. 7, is a straight, cylindrical member which is substantially parallel with primary axis A1.

In an exemplary embodiment, first and third angled portions 256 and 252 are substantially parallel with respect to each other, and are between 14-20 inches apart. In a preferred embodiment, first and third angled portions 256 and 252 are approximately 16 inches apart. Furthermore, second and fourth angled portions 254 and 250 are substantially parallel with respect to each other, and are also between 14-20 inches apart. In a preferred embodiment, second and forth angled portions 254 and 250 are approximately 16 inches apart.

In an exemplary embodiment, first and third angled portions 256 and 252 are substantially parallel with respect to each other. Furthermore, second and fourth angled portions 254 and 250 are substantially parallel with respect to each other. The four angled portions 256, 254, 252, and 250 form an ergonomic, selective gripping structure for extension 214.

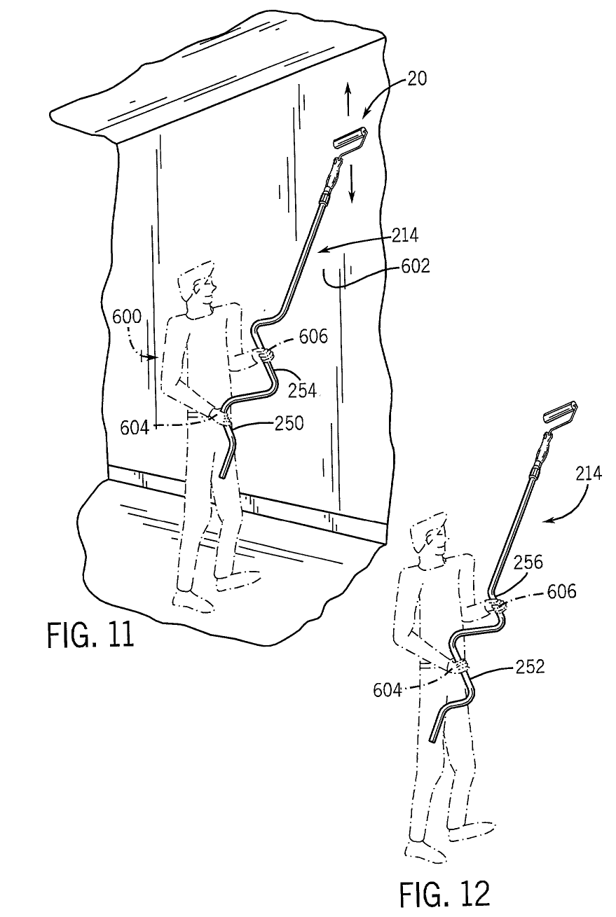

Referring to FIGS. 11-12, a user 600 is shown gripping and using extension 214 to apply paint to vertical wall 602 using roller 20. In FIG. 11, user 600 is shown placing hands 604 and 606 on second and fourth angled portions 254 and 250. Alternatively as shown in FIG. 12, user 600 is shown placing hands 604 and 606 on first and third angled portions 256 and 252. Placing hands 604 and 606 on parallel portions offers the user 600 a comfortable feel while using extension 214. Stress and fatigue on user 600 is lessened by allowing user 600 to hold extension 214 is a more natural position on parallel portions 256 and 252, or 254 and 250, rather than holding a typical, straight extension pole. User 600 may selectively choose from two gripping positions based on criteria such as user comfort, space constraints, etc.

To further increase user's 600 comfort, the extensions described above may be alternatively be fitted with grips. Grips may be a soft cushion foam disposed on the various angled and straight portions of the extensions. Grips may be capable of elastic deformation in user's hands 604 and 606, thereby increasing comfort. Alternatively, grips may be a flexible rubber, santoprene or elastomer which increases user's grip. Although such grips are described as being in a particular orientation, the grips may alternatively be orientated in different planes depending upon the exact configuration of the extension.

As shown in FIG. 7, second and third angled portions 254 and 252 cross primary axis A1. By crossing primary axis A1, a user may place hand 606 and 604 in line with the axis of extension 214 (i.e. axis Al). With hands in line with the primary axis of extension 214, a user may develop more force directed along the primary axis, thus with less effort.

Referring to FIG. 8, extension 314 is shown similar to extension 214. The angled portions 356, 354, 352, and 350 extend obliquely away from primary axis A1 at an angle between 30° and 170°. In a preferred embodiment, the angle is between 120° and 140°. In a particularly preferred embodiment, the angle is 139°. Furthermore, angled portions 356, 354, 352, and 350 may all be disposed on one side of the primary axis A1 of extension 314. This configuration provides ergonomic advantages similar to extension 214, and is of a smaller size, thus minimizing problems associated with space constraints.

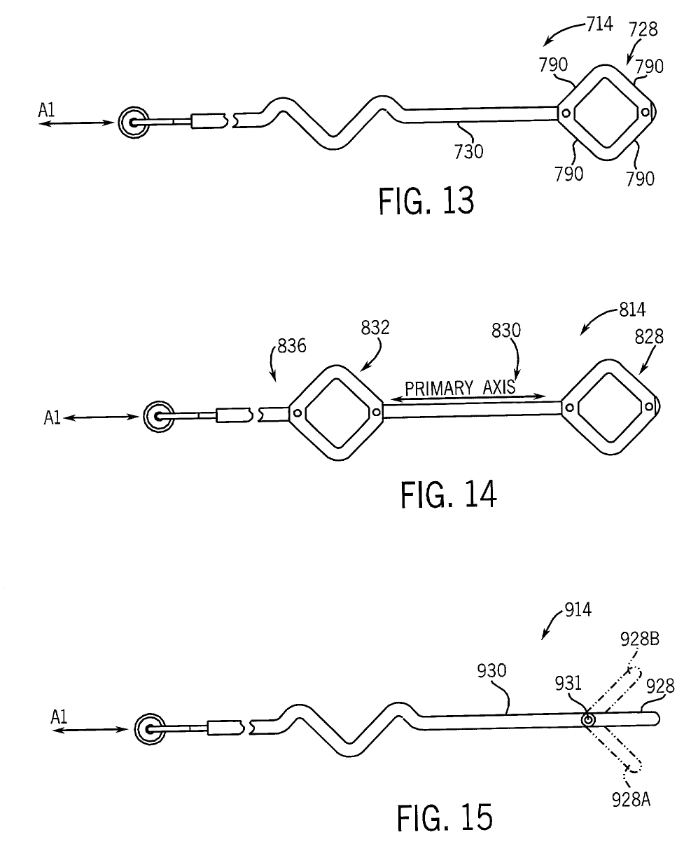

In alternative embodiments, the extensions described above may be fitted with an alternative gripping member as shown in FIG. 13. Extension 714 is similar to extension 214. However, extension 714 includes hoop 728 coupled to proximal portion 730. Hoop 728 has a substantially square shape. Alternatively, hoop 728 could be any number of shapes and geometries including diamond, rectangular, rhombodial, circular, triangular, etc. Hoop 728 provides several gripping positions 790. It should be appreciated that the number of gripping positions will vary depending upon the geometry chosen for hoop 728. In an exemplary embodiment, gripping positions 790 have substantially the same cross sectional shape and size as proximal portion 730.

In alternative embodiments, the extensions described above may be fitted with an alternative gripping member as shown in FIG. 14. Extension 814 is similar to extension 714. However, extension 814 includes hoops 828 and 832. Hoop 828 is coupled to proximal portion 830. Proximal portion 830 is coupled to hoop 832, and hoop 832 is coupled to distal portion 836. Hoops 828 and 832; proximal portion 830, and distal portion 836 are substantially aligned along primary axis A1.

In another alternative embodiment, the extensions described above may be fitted with an alternative gripping member as shown in FIG. 15. Extension 914 is similar to 214. However, extension 914 includes an adjustable end portion 928 coupled to proximal portion 930. Adjustable end portion 928 may be coupled to proximal portion 930 with hinge 931. Hinge 931 allows repositioning of adjustable end portion 928 in a plurality of selected positions. For example, adjustable end portion 928 may be repositioned between position 928A and 928B, thereby allowing a user to hold extension 914 in a different position. Furthermore, hinge 931 may include a locking mechanism (not shown) to allow adjustable end portion 928 to be rigidly fixed in a selected position.

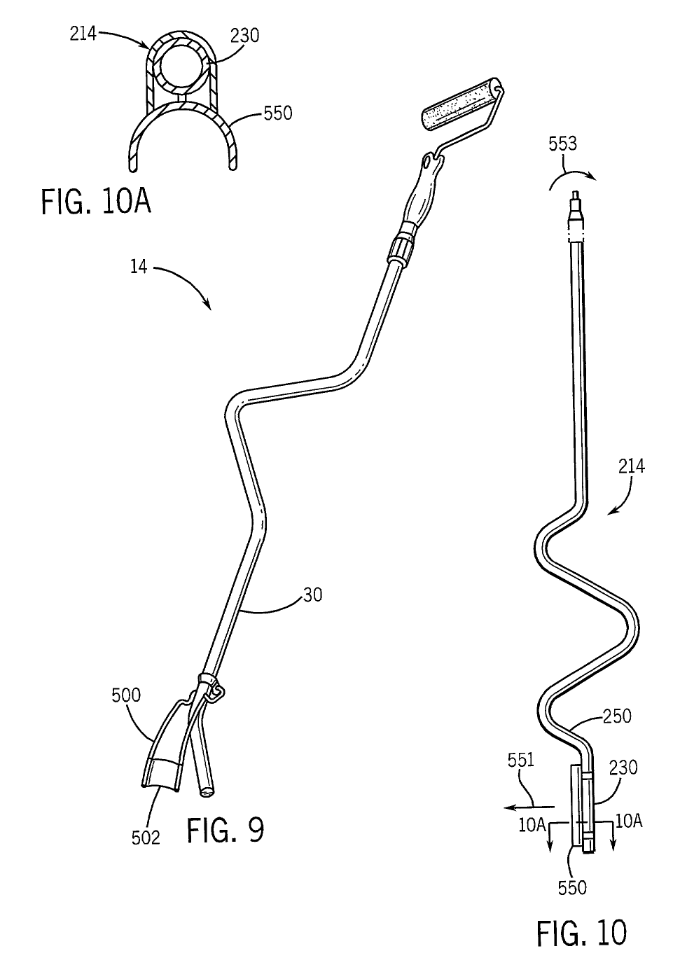

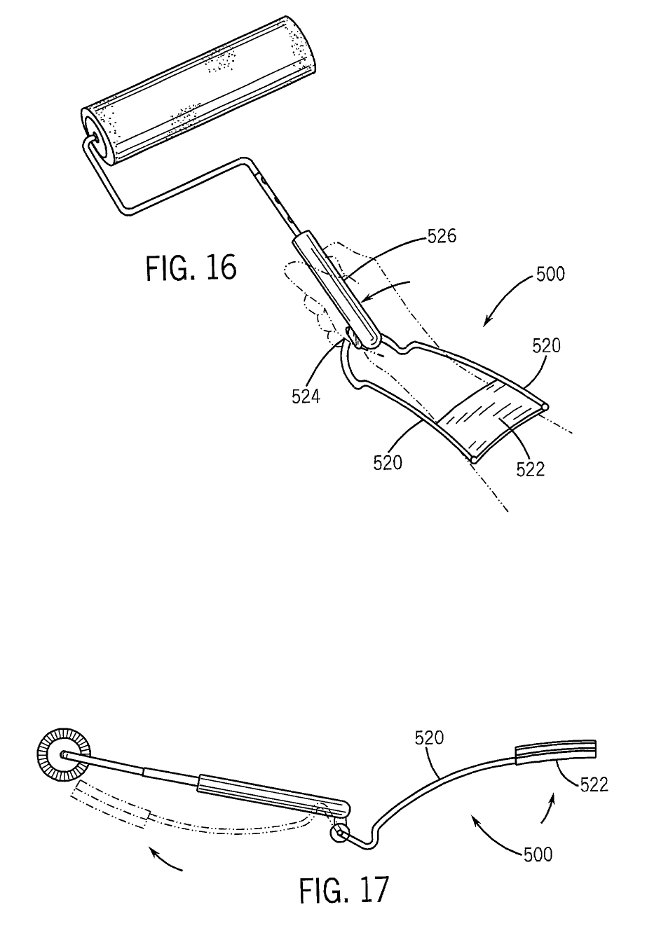

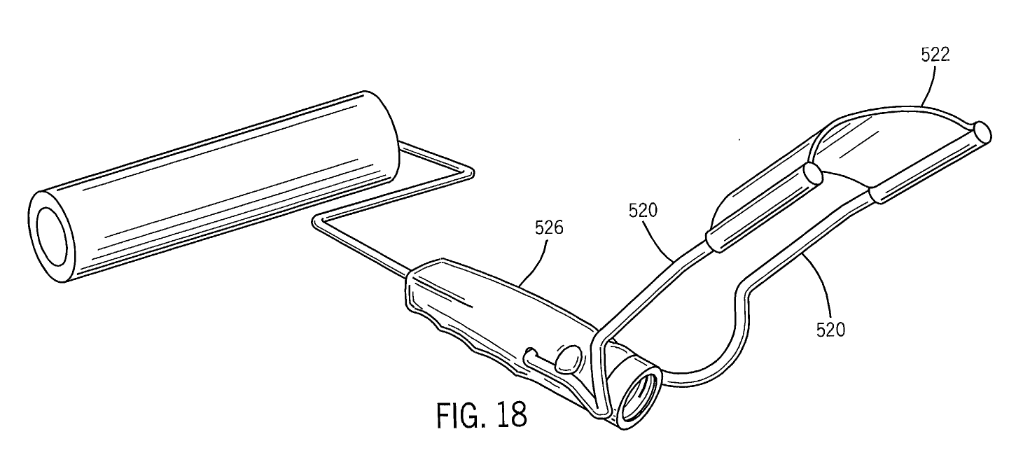

In alternative embodiments, the extensions described above may be fitted with an arm brace 500 as shown in FIG. 9. Brace 500 may be of a type disclosed on U.S. patent application (Attorney Docket No. 62759/336), titled “Forearm Support for Paint Applicator,” the full disclosure of which is incorporated by reference. Brace 500 is shown in greater detail in FIGS. 16-18. In FIGS. 16-19, brace 500 is shown attached to a roller similar to roller 12. It should be appreciated that brace 500 may be attached to a variety of implements including handle 526 of roller 12, or alternatively, the extensions disclosed above (extensions 14, 114, 214 and 314). For example, brace 500 may be fitted upon proximal portion 30 adjacent to end grip portion 28 of extension 14, proximal 230 of extension 214, proximal portion 330 of extension 314 or portion 130 approximate to 128 of extension 114.

As shown in greater detail in FIG. 16 through 19, brace 500 generally includes mount 524, arms 520, and support 522. Mount 524 may be coupled to a handle 526 of roller 12 (as shown in FIG. 16) or the end portion of extensions 14, 114, 214, and 314 as shown in FIGS. 9-10. As shown in FIG. 17, arms 520 are rotatably coupled to mount 524 by hinge 528. Alternatively, arms 520 may be rotatably coupled directly to handle 526 of roller 12 (as shown in FIG. 18). Support 522 is a curved surface that connects arms 520. Support 522 is configured to fit a user's forearm (as shown in FIG. 16). With user's forearm supported, user may grasp a gripping portion of the extension, and be able to move and manipulate the extension only with one arm, whereas use of the extension without brace 500 may require two arms.

FIG. 10 illustrates extension 214 further equipped with brace 550 mounted to proximal portion 230. Brace 550 generally comprises a rigid semi-cylindrical cradle mounted to portion 230 along the axis of portion 230. Brace 550 has an elongated concave surface facing in the direction of arrow 551. When a painter grasps extension 214 with one of his or her hands gripping angle portion 250, the cradle provided by brace 550 receives the painters forearm such that the torque created by extension 214 in the direction indicated by arrow 553 is borne by the painter's forearm. As a result, the painter may temporarily hold extension 214 with one hand or may utilize sprays 550 to reduce the strain imposed on his or her arms as the painter wheels extension 214 and the paint roller attached to its end.

In the exemplary embodiment, brace 550 is releaseably mounted to portion 230. Similar to brace 500, brace 550 may alternatively be mounted to extensions having other configurations. Although brace 550 is illustrated as being releaseably mounted to extension 214, brace 550 may alternatively be integrally formed as part of a single unitary body with brace 214. Furthermore, a wheel simply comprising a semi-cylindrical rigid member, brace 550 may additionally include a soft flexible fabric, netting or other material within the concavity of brace 550 to provide a more comfortable fit partially about the painter's forearm when employed. Brace 550 may further be provided with a strap, band or other structure configured to wrap about the opposite side of the painter's forearm.

In FIG. 9, brace 500 is shown disposed on proximal portion 230 of extension 214. In FIG. 10, brace 500 is shown disposed on proximal portion 30 of extension 30. Proximal portion 30 or 230 is preferably parallel to primary axis A1. Such configuration is optimal for mounting and using brace 500 to an extension. It should be appreciated that the extensions shown in FIGS. 9-10 are only for illustrative purposes. Furthermore, any of the extensions described herein are suitable for mounting and use of brace 500. In alternative embodiments, brace 550 may have a tubular shape or a round or oval cross-sectional shape so as to receive the painter's entire forearm to control both upward and downward forces.

In alternative embodiments, the extensions described above (e.g. 14, 114, 214 and 314) may be fitted with a retractable portion 80 as shown in FIG. 4. Retractable portion 80 is a substantially cylindrical portion configured to slidably fit within a cavity 82 in distal portion 36. Retractable portion 80 may selectively be extended to add further length to an extension. As shown in FIGS. 34, a locking member, shown as locking member 84 may be included to allow a user to selectively release retractable portion 80 from distal portion 36, allowing for the free extension of retractable portion 80 along primary axis A1. In a unlocked position, retractable portion 80 is free to move along primary axis A1, as well as to rotate around axis A1. Free rotation around axis A1 allows a user to properly position roller 12 with respect to both extension 14 and the surface to be painted. An example of retractable portion 80 is shown in U.S. Pat. No. 5,598,598 and U.S. Pat. No. 5,983,455, the full disclosure of which are hereby incorporated by reference.

Retractable portion 80 is selectively locked and unlocked with respect to distal portion 36 as follows. Locking member 86 includes clamping portion 88 disposed on an end of distal portion 36, and nut 90. Clamping portion 88 includes fingers 92 disposed on a first end of clamping portion 88, and threaded portion 94 disposed on an opposing end of clamping portion 88. In an exemplary embodiment, fingers 92 are sized to receive retractable portion 80 and allow slidable motion of retractable portion 80 when fingers 92 are in an uncompressed state. In order to lock retractable portion 80 with respect to distal portion 36 (both axially and in rotation), nut 90 engages threaded portion 94. As nut 90 is tightened, fingers 92 are compressed inwardly and grasp retractable portion 80, thereby preventing relative motion between retractable portion 80 and distal portion 36.

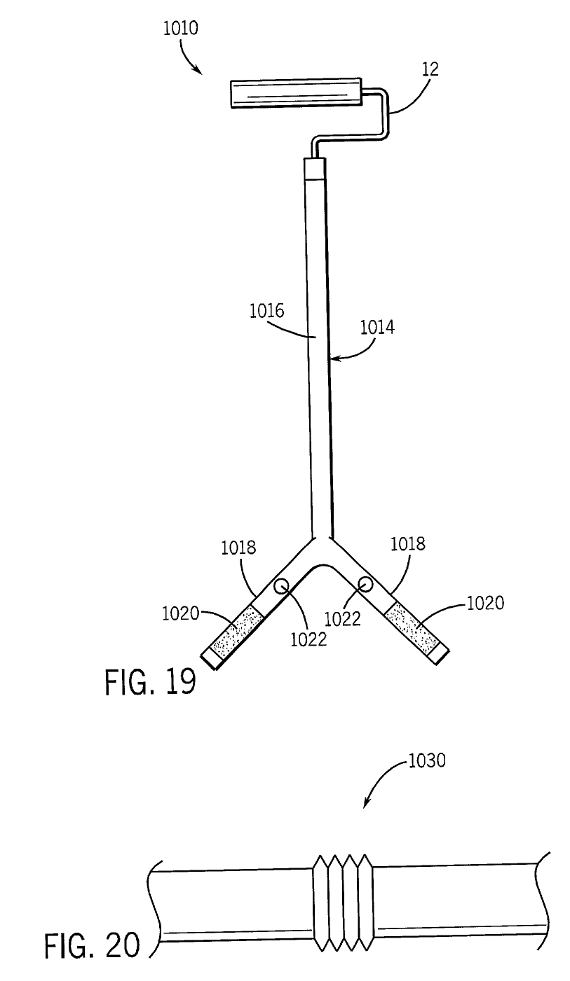

FIG. 19 is a top elevational view of paint roller and extension system 1010 generally including paint roller 12 and extension 1014. Paint roller 12 is essentially identical to paint roller 12 described with respect to FIGS. 1 and 5. As will be appreciated, extension 1014 may also be employed with a variety of alternative paint rollers.

Extension 1014 comprises an elongate pole composed of one or more interval sections. Extension pole 1014 generally includes a linear portion 1016 and a pair of bifurcated end portions 1018. Portion 1016 extends from end portions 1018 and is configured to mount to paint roller 12. Although portions 1016 is illustrated as being preferably linear, portions 1016 may alternatively include one or more bends similar to that of extensions 14, 114, 214 and 314. Such bends may be provided with gripping surfaces to provide a painter with varied gripping points to reduce fatigue.

End portions 1018 extend from portion 1016 and diverge from one another. In an exemplary embodiment, portions 1018 diverge from one another at an angle of approximately 45°. Alternatively, end portions 1018 may diverge from one another at various other angles. End portions 1018 enable system 1010 and extension pole 1014 to be simultaneously gripped and held by two hands. In the exemplary embodiment, each of portions 1 018 includes a soft elastomeric gripping sleeve 1020. In addition, each portion 1018 includes an optional coast or handle bar 1022. Each bar 1022 has a height sufficient so as the user's entire hand can wrap about the bar. Preferably, such bars 1022 provided with finger grips and with a soft compressible outer circumferential surface. Bars 1022 enable the painter to grip portions 1018 at an angle approximately 90° relative to the axis of the plane containing the axes of grips 1020. In alternative embodiments, extension pole 1014 may be additionally provided with braces 500 or 550 mounted over top of grips 1020. In addition, grips 1020 may also be replaced with cylindrical or tubular arm braces which receive and surround the entirety of the painter's forearm. In such an alternative embodiment, the user would extend his or her arms against the brace while gripping bars 1022.

The extensions described above may be constructed of a unitary member. Alternatively, each extension may be formed from a plurality of individual sections releaseably or adjustably mounted to one another. For example, such sections may be connected together with a two style connection or other adjustable type connection. As a result, such sections could be adjusted relative to one another to obtain appropriate angles while rotating the sections relative to one another or appropriate lengths by telescopically extending the sections relative to one another. According to an alternative embodiment, the extensions may include (or be connected to one another by) flexible sections or joints (e.g., a plurality of ramped segments 1030 (shown in FIG. 20) configured to allow movement (e.g., pivoting, twisting, extending, retracting, etc.) of one extension relative to another extension (or one portion of an extension relative to another portion of the extension). In an exemplary embodiment, extensions are constructed from a unitary aluminum member with a cross-sectional diameter of between 1.0 and 1.5 inches. Alternatively, the extensions may be constructed of other differing materials, sizes and cross-sectional shapes and sizes or diameters. For example, the extension may be constructed from steel, plastic, aluminum or metal alloys, carbon fiber, dye drawn polypropylene or composites of any of the aforementioned materials and other existing materials or materials developed hereafter. etc. Moreover, different sections of each extension may be made from different materials for better weight distribution. According to any exemplary embodiment, the extensions may be formed from any of a variety of materials using any of a variety of manufacturing methods. According to a preferred embodiment, the extensions are made from solid and/or rigid components or materials. According to an alternative embodiment, the extensions may be made from flexible components or materials (e.g., flexible tubing, plastic tubing, etc.). Alternatively, the extensions may be made of a combination of rigid and flexible components and materials. Furthermore, the extensions may have a square, hexagonal, octagonal or other variously shaped cross sections.

The extensions described above are constructed by bending the member to the desired shape and orientation. Alternatively, other methods of construction may be used in assembling the various extensions including welding, threading, fasteners such as bolts and screws, etc.

In the exemplary embodiments described above, the gripping portions (i.e. angled portions, proximal portions, distal portions and end portions) typically have a length of at least 5 inches to provide sufficient space for gripping. Although the gripping portions are illustrated as being generally fixed, such gripping sections may alternatively comprise handles or other areas which are adjustable or moveable along the axis of the portion or section to which such handles are attached. In leu of simply comprising a sleeve of soft compressible foam or other elastomeric material, such gripping surfaces may additionally be provided with bumps or ridges for improved finger grip. In particular embodiments, such gripping portions may be provided with a glove mounted to the pole for providing a precise grip location.

The exemplary embodiments described above possess several advantages for a user. One such advantage is the extensions described above are capable of accommodating a right-handed or left-handed user. Furthermore, the extensions described above can easily be rotated around their primary axis and be used in a variety of orientations, including orientations based on user preference, comfort, space constraints, etc. Although the extensions are illustrated in conjunction with a roller cover which must be manually loaded with paint from a paint tray or paint bucket, the extensions may alternatively be employed with paint rollers which are fed with paint or other liquid coatings within the interior of the roller cover and through perforations in the roller cover. In such alternative applications, a paint supply passage or paint supply fluid line may be provided through the interior of the extension. Each of the extensions may also be provided as part of an ergonomic paint accessory kit.

Although the present invention has been described with reference to preferred and exemplary embodiments, persons skilled in the art will recognize that changes may be made in form and detail without departing from the spirit and scope of the invention. The present invention described with reference to the preferred and exemplary embodiments and set forth in the following claims is manifestly intended to be as broad as possible. For example, unless specifically otherwise noted, the claims reciting a single particular element also encompass a plurality of such particular elements.

What is claimed is:

1. An extension for a paint applicator, comprising:
a first end configured to be coupled to the paint applicator;
a distal portion coupled to the first end, the distal portion parallel to a primary axis;
a first angled portion coupled to the distal portion;
a second angled portion coupled to the first angled portion; and
a proximal portion coupled to the second angled portion, wherein the proximal portion is parallel to the primary axis.

2. The extension of claim 1 wherein the proximal portion is configured to receive an arm brace.

3. The extension of claim 2, further comprising an arm brace disposed on the proximal portion.

4. The extension of claim 1 wherein the distal portion, first angled portion, second angled portion, and proximal portion are coupled by a unitary construction.

5. The extension of claim 4, wherein the distal portion, first angled portion, second angled portion, and proximal portion are constructed from a unitary aluminum member.

6. The extension of claim 1, further comprising a retractable portion disposed in a cavity of the distal portion, wherein the retractable portion is slidable parallel to the primary axis.

7. The extension of claim 6, further comprising a locking member configured to allow selective releasing of the retractable portion.

8. The extension of claim 1, wherein an angle between the first angled portion and the primary axis, and an angle between the second angled portion and the primary axis is between 75 and 160 degrees.

9. The extension of claim 8, wherein the angle between first and second angled portion is between 120 and 140 degrees.

10. The extension of claim 1, further comprising a handle disposed on the second angled portion.

11. The extension of claim 1, further comprising a handle disposed on the proximal portion.

12. The extension of claim 1, further comprising an end portion coupled to the proximal portion.

13. The extension of claim 12, wherein the end portion and second angled portion are substantially parallel.

14. An extension for a paint applicator, comprising:
a first end configured to be coupled to the paint applicator;
a distal portion coupled to the first end, the distal portion parallel to a primary axis;
an angled portion coupled to the distal portion;
a proximal portion coupled to the second angled portion, wherein the proximal portion is parallel to the primary axis; and
an end portion substantially parallel to the angled portion.

15. The extension of claim 14 wherein the proximal portion is configured to receive an arm brace.

16. The extension of claim 15, further comprising an arm brace disposed on the proximal portion.

17. The extension of claim 14 wherein the distal portion, first angled portion and proximal portion are coupled by a unitary construction.

18. The extension of claim 17, wherein the distal portion, first angled portion and proximal portion are constructed from a unitary aluminum member.

19. The extension of claim 14, further comprising a retractable portion disposed in a cavity of the distal portion, wherein the retractable portion is slidable parallel to the primary axis.

20. The extension of claim 19, further comprising a locking member configured to allow selective releasing of retractable portion.

21. The extension of claim 14, wherein an angle between the distal portion and the first angled portion is between 75 and 160 degrees.

22. The extension of claim 21, wherein the angle between the distal portion and the first angled portion is between 120 and 140 degrees.

23. The extension of claim 14, further comprising a handle disposed on the first angled portion.

24. The extension of claim 14, further comprising a handle disposed on the proximal portion.

25. The extension of claim 14, further comprising an end portion coupled to the proximal portion.

26. The extension of claim 25, wherein the end portion and first angled portion are substantially parallel.

27. An extension for a paint applicator, comprising:
a first end configured to be coupled to the paint applicator;
a distal portion coupled to the first end, the distal portion extending parallel to a primary axis;
a first angled portion coupled to the distal portion;
a second angled portion coupled to the first angled portion;
a third angled portion coupled to the second angled portion, the third angled portion substantially parallel to the first angled portion;
a fourth angled portion coupled to the third angled portion, the fourth angled portion substantially parallel to the second angled portion; and
a proximal portion coupled to the fourth angled portion, wherein the proximal portion is parallel to the primary axis.

28. The extension of claim 27 wherein the proximal portion is configured to receive an arm brace.

29. The extension of claim 28, further comprising an arm brace disposed on the proximal portion.

30. The extension of claim 27 wherein the distal portion, first angled portion, second angled portion, and proximal portion are coupled by a unitary construction.

31. The extension of claim 30, wherein the distal portion, first angled portion, second angled portion, and proximal portion are constructed from a unitary aluminum member.

32. The extension of claim 27, further comprising a retractable portion disposed in a cavity of the distal portion, wherein the retractable portion is slidable parallel to the primary axis.

33. The extension of claim 32, further comprising a locking member configured to allow selective releasing of the retractable portion.

34. The extension of claim 27, wherein an angle between the first angled portion and the primary axis, an angle between the second angled portion and the primary axis, the third angled portion and the primary axis, and the fourth angled portion and the primary axis is between 75 and 160 degrees.

35. The extension of claim 34, wherein the angles are between 120 and 140 degrees.

36. The extension of claim 27, further comprising a handle disposed on the second angled portion.

37. The extension of claim 27, further comprising a handle disposed on the proximal portion.

38. The extension of claim 27, further comprising an end portion coupled to the proximal portion.

39. The extension of claim 38, wherein the end portion and second angled portion are substantially parallel.

40. The extension of claim 38, wherein the end portion is adjustable with respect to the primary axis.

41. The extension of claim 40, further comprising a hinge, wherein the hinge rotatably couples the end portion and the proximal portion.

42. The extension of claim 38, wherein the end portion further comprises a hoop.

43. The extension of claim 38, wherein the end portion and second angled portion are substantially parallel.

44. An extension for a paint applicator, comprising:
a first end configured to be coupled to the paint applicator;
a distal portion coupled to the first end, the distal portion extending parallel to a primary axis;
a first hoop coupled to the distal portion;
a proximal portion coupled to the first hoop; and
a second hoop coupled to the proximal portion.

45. The extension of claim 44, wherein the first and second hoops are polygonal.

46. The extension of claim 45, wherein the first and second hoops are diamond shaped.

47. The extension of claim 44, wherein the first and second hoops are square shaped.

48. The extension of claim 44, further comprising a retractable portion disposed in a cavity of the distal portion, wherein the retractable portion is slidable parallel to the primary axis.

49. The extension of claim 44, further comprising a locking member configured to allow selective releasing of the retractable portion.
